(19) United States
(12) Patent Application Publication
(10) Pub. No.: US 2023/0186705 A1
(43) Pub. Date: Jun. 15, 2023

(54) RENTAL GUEST VERIFICATION SYSTEM AND METHOD

(71) Applicant: Kevin Cannon, Windermere, FL (US)

(72) Inventor: Kevin Cannon, Windermere, FL (US)

(21) Appl. No.: 18/081,202

(22) Filed: Dec. 14, 2022

Related U.S. Application Data
(60) Provisional application No. 63/290,013, filed on Dec. 15, 2021.

(51) Int. Cl. G07C 9/25; G07C 9/27; G07C 9/00; G06Q 10/02

(52) U.S. Cl. CPC G07C 9/25; G06Q 10/02; G07C 9/27; G07C 9/00309; G07C 9/00896; G07C 2009/00769; G07C 2009/00936

(57) ABSTRACT

A rental guest verification system and method include a community access platform having at least one unit access device, a plurality of community access devices, a local server and a platform provider system. The platform provider system is in communication with the local server and creates a property owner portal for use by a property owner. A guest seeking to rent a unit from the property owner provides information through a guest portal and undergoes an identity and background check. A digital key is linked to the guest portal of the guest upon a successful background check. Upon arriving at the rental property, the guest portal captures a real time image of the guest and compares the same to the images used in the background check. If the comparison is a match, the guest key is activated to unlock the unit access device and community access devices.

### CROSS-REFERENCE TO RELATED APPLICATIONS

This application claims the benefit of U.S. Application Serial No. 63/290,013 filed on Dec. 15, 2021, the contents of which are incorporated herein by reference.

### TECHNICAL FIELD

The present invention relates generally to the vacation rental industry, and more particularly to a system and method for performing auditable identity verification for rental guests.

### BACKGROUND

The statements in this section merely provide background information related to the present disclosure and may not constitute prior art.

In recent years, there has been a drastic increase in the number of property unit owners who choose to rent their properties as short term vacation rentals. To this end, there are several third-party companies which utilize the internet to assist property owners in advertising, listing, and renting subject properties to individuals seeking lodging.

Although this process works well to ensure the owner is paid for the rental, there is currently no way to ensure that the individual who rented the property is the same individual who stays there. This anonymity has led to an increasing number of reports of criminal activity occurring by individuals staying at subject properties such as prostitution, robberies, and burglaries, for example. In addition to criminal activity, these actions leave the condo association or homeowner association exposed to potential suits for negligence for failing to monitor activities of property owners.

Moreover, because these individuals are not residents, they typically do not follow the Homeowner or condo association rules which are meant to ensure harmony among all residents of the property. Additionally, the drastic increase in usage caused by these short-term rentals often results in additional expenses on behalf of the unit association that are ultimately paid by all unit property owners, rather than those renting their units.

Accordingly, it would be beneficial to provide a rental audit and verification system that can be utilized in these situations to verify the identity of individuals renting and staying at subject properties, providing a virtual front desk for rental guests and for providing the homeowner association with auditable information about such guests.

### SUMMARY OF THE INVENTION

The present invention is directed to a rental guest verification system and method. One embodiment of the present invention can include a community access platform having at least one unit access device, a plurality of community access devices, a local server, and a platform provider system. The platform provider system can be in communication with the local server and can create a property owner portal for use by a property owner.

In one embodiment, a guest seeking to rent a unit from the property owner can receive a reservation link from the property owner to download a guest portal created by the platform provider. The reservation link can take the guest to a background check screen where the guest can provide identification and undergo an identity and background check.

In one embodiment, the system can automatically generate a digital key and connect the same to the guest portal upon a successful background check. In one embodiment, the system can automatically deny a reservation request based upon an unsuccessful background check. In one embodiment, the system can provide instructions to the owner portal to manually approve or deny a reservation request based upon an inconclusive background check result.

In one embodiment, upon arriving at a property, a guest can check-in using their guest portal. Upon selecting check in, the guest portal can capture an image of the guest at the property. The image can be compared to the images used in the background check. If the comparison is a match, the guest key can be activated for use by the guest to wirelessly unlock the unit access device and any associated community access devices using the guest portal.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 shows an exemplary network environment of a rental guest verification system according to some embodiments of the technology.

FIG. 2 shows an exemplary view of the community access platform of the system, in accordance with one embodiment.

FIG. 3 shows an exemplary flow diagram illustrating a method for implementing a rental guest verification system, according to one embodiment.

FIG. 4 shows an exemplary flow diagram illustrating a method of using the rental guest verification system to reserve and conduct a background check on an Applicant, according to one embodiment.

FIGS. 5 and 6 each show exemplary interface presentation screens of the system, in accordance with one embodiment.

FIG. 7 shows an exemplary flow diagram illustrating a method of using the Rental Guest Verification System to access a rental unit and community grounds, according to one embodiment.

FIGS. 8A-8C each show exemplary interface presentation screens of the system, in accordance with one embodiment.

### DETAILED DESCRIPTION OF THE INVENTION

While the specification concludes with claims defining the features of the invention that are regarded as novel, it is believed that the invention will be better understood from consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, the term “Community Association” can be the legal entity (and its representatives) for a particular housing community (e.g., condo, house, etc.) that is authorized to establish, maintain and/or enforce a set of community rules (e.g., covenants, conditions, and restrictions) for the particular community.

The term “property owner” describes any individual, group or entity that owns a “Unit” within the community and wishes to offer the unit as a short-term rental to a guest.

The term “guest” describes any person who utilizes one or more aspects of the system to reserve and/or stay at a rental unit located in the community.

The term “listing site” describes any company, group or individuals that provide property rental listings and/or booking services to property owners seeking to rent their units within a community.

The term “platform provider” describes the individual, group or legal entity that is overseeing the below described system in order to perform the methods described herein. In the preferred embodiment, the platform provider will operate under the name Guest Base and will utilize a website having the same or similar name, however other names are also contemplated.

As described herein, the term “community reports” can include any information from the below described community access platform and interface devices pertaining to the unit(s) being offered as rental properties to guests using the system. This information can include, but is not limited to rental unit offering details, guest identification information, unit occupancy information, guest access information, and guest background check information, for example.

In various embodiments, portions of the below described system and method can be performed on or include the use of a website having any number of different URL addresses. Additionally, it is contemplated that several different methods and/or method steps can be performed simultaneously via different websites that are directed towards different individual markets, and/or geographic locales. In this regard, use and/or operation of the system is not to be construed as limiting to a particular site. Such methods can be performed under the direct supervision of the original platform provider, or via secondary providers through a franchise or other agreement.

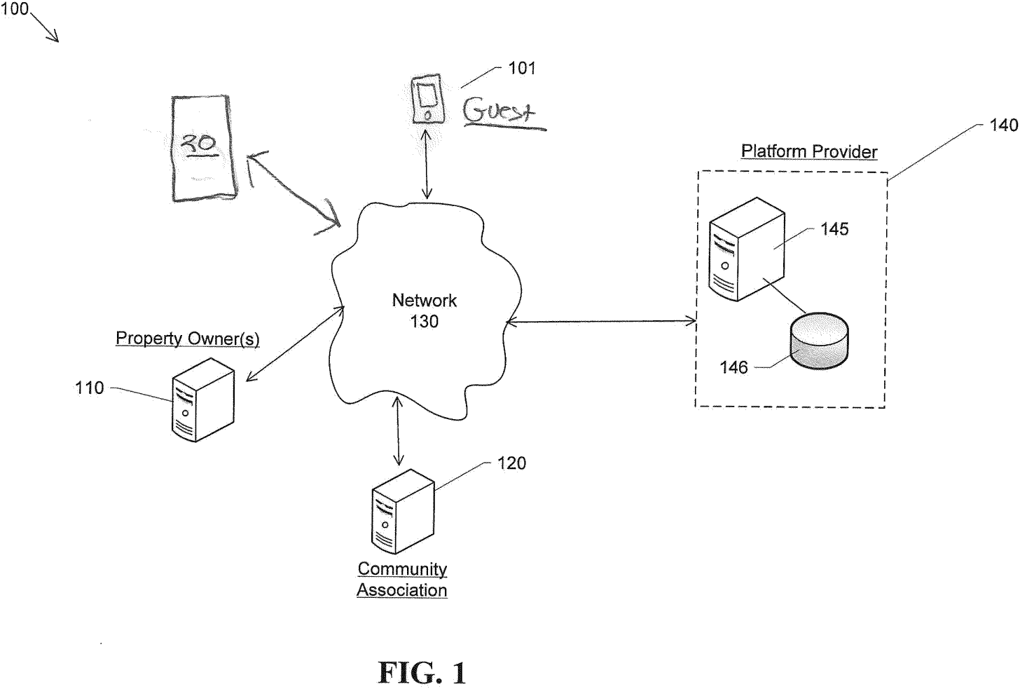

FIG. 1 is a block diagram of an example operating environment for the rental audit and verification system on which the below described methodology may be implemented.

In one embodiment, the system 100 can include, for example, a community access platform 20, at least one guest interface device 101 operated by a guest, at least one Property Owner interface device 110 that is operated by a Property Owner, and a Community Association interface device 120 that is operated by a Community Association. Each of the interface devices are connected over a network 130 to a Platform Provider server 140 that is operated by the platform provider.

Each of the one or more interface devices 101, 110, and 120 can be any form of computing device that can be operated or controlled by a human user to perform the below described methodology. A computing device refers to any device with a processor and memory that can execute instructions and communicate with another device. Computing devices include, but are not limited to, smartphones, tablet computers, personal computers, laptop computers and/or purpose-built machines that are pre-encoded with an application interface, so as to perform the functionality so described.

In the preferred embodiment, the guest interface device 101 can comprise a smartphone device having a web browser, internet connectivity, a location determination module (e.g., cellular location services), a display screen and a camera. Moreover, the below described guest Portal can include a mobile application (i.e., Apps) that can be downloaded and installed as an application for use on the smartphone or other such portable electronic device. Of course, the inventive concepts disclosed herein are not to be construed as limiting to a mobile application, as virtually any type of instruction sets, in any form of programming language that can be executed on any type of processor enabled device are also contemplated.

In either instance, each of the computing devices can include one or more client applications, such as a conventional web browser, and/or an application interface, for example, which can allow the device to communicate with other interface devices and/or the platform provider 140 over a network 130.

The Platform Provider server 140, according to one embodiment, can include one or more individual computing devices 145 that can be connected to one or more databases 146 on which various portions of the method can be performed. The server 140 can function to provide a central hub for controlling the communication between the user interfaces through any number of different mediums such as the above noted website, for example. In this regard, one or more of the individual computing devices 145 can comprise a web server, an email server, an application database server and so forth, or the system can employ a single server device which functions to handle each of these processes.

In this regard, portions of the described methodology can be implemented as a computer program product, i.e., a computer program tangibly embodied in a non-transient machine-readable storage device, for execution by, or to control the operation of, a data processing apparatus. The computer program can be written in any form of computer or programming language, including source code, compiled code, interpreted code, scripting code (e.g., JavaScript) and/or machine code, and the computer program can be deployed in any form, including as a stand-alone program or as a subroutine, element, or other unit suitable for use in a computing environment.

As such, the system can function to generate a plurality of portals on which users of the interface devices can send and receive information. Several nonlimiting examples of portals can include but are not limited to an owner portal for use by a property owner, a guest Portal for use by a guest, an Association portal for use by a community association and a guest Base administrative portal provided by the Platform provider, among others, for example.

The database 146 can function to receive and store information such as guest information, property information, property listings, contact information, community association information and more. As described herein, the database 146 can include any type of computer-readable storage mediums, including all forms of volatile and non-volatile memory such as, for example, semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. In addition, the devices can be operatively coupled to a communications network, such as network 130, to receive instructions and/or data from the network and/or to transfer instructions and/or data to the network. In one embodiment, the database or a portion thereof can include, comprise, or consist of blockchain technology for creating and storing information.

The network 130 is a communication network that that facilitates any form or medium or digital or analog communication such as a cellular network, a local area network (“LAN”), an intranet, a wide area network (“WAN”), the internet, and/or any other type of data transmission and reception medium.

As will be described below, system 100 provides a mechanism for verifying the identity of a guest renting a unit within a community. Upon successful identity verification, the system can provide guests with access to the community grounds, check-in/check-out services at the particular unit, and can provide the community association information about the guest(s) and their activities at the community.

As noted in the examples below, the guest user interface device 101 can be operated by the individual seeking to rent and stay at a unit of a community. The Property Owner interface device 110 can be operated by the owner (or their representative) of the unit at the community. The Community Association interface device 120 can be operated by any designated member of a community association, such as the board of directors, for example, and can function to receive reports and other information pertaining to listings of units, and guests of the units.

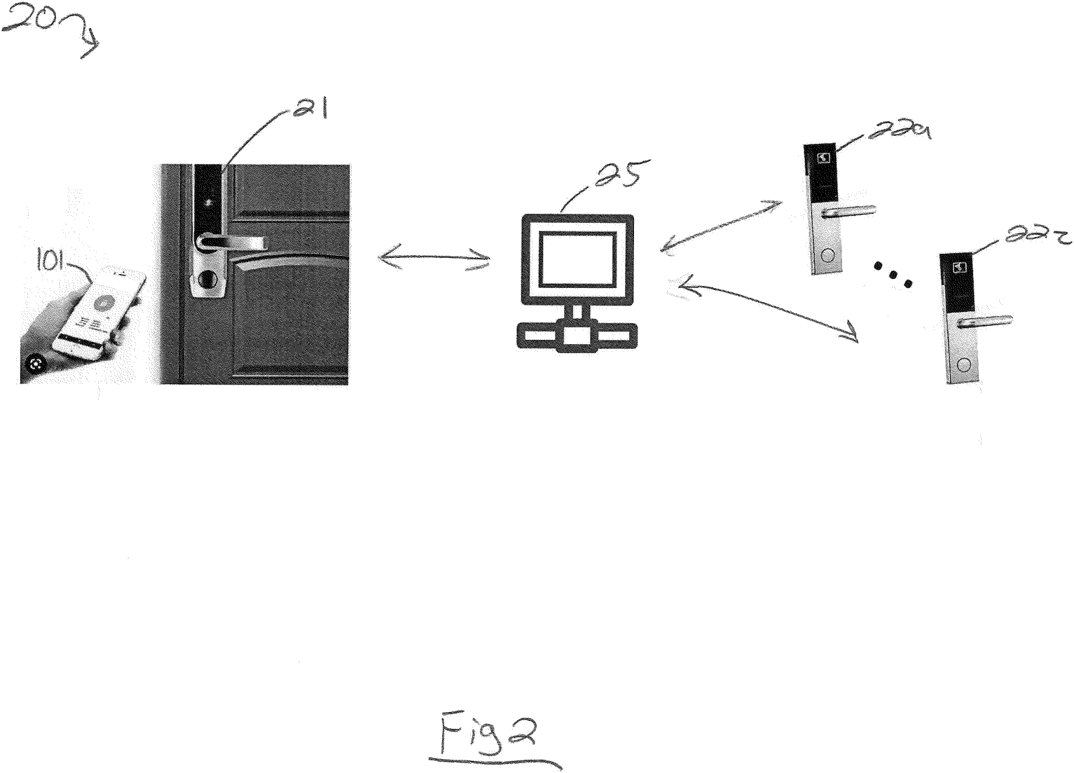

FIG. 2 illustrates one embodiment of a community access platform 20 for use with the system 100. Platform 20 can include at least one rental unit access device 21 and a plurality of community access devices 22 that are each in communication with a local computer or server 25. In the preferred embodiment, the community access platform 20 components can be provided by the platform provider to the community association upon successful registration of the community as outlined below.

The device components can be installed throughout the community and can function to allow access to the community and rental unit via a unique guest key that is generated upon successful on-site verification of a guest’s identity.

The server 25 can include a computer device that is connected to the platform provider 140 over the network 130. The server is also connected to each of the access devices 21 and 22a-22z (22a-22z hereafter being referred to collectively as 22). In one embodiment, the server can function to receive unique guest key information from the platform provider, along with information about which access device(s) 21 and 22 the key is able to unlock and the timeframe/duration where the access is granted. When a guest attempts to unlock an access device, the guest key is compared with the stored guest key and permission is granted or denied based on the comparison.

As described herein, each of the unit access device(s) 21 and the community access device(s) 22 can include, comprise, or consist of any number of devices which can be selectively operated to allow a guest to open a door or other barrier so as to access a rental unit or other location within the community (e.g., pool, parking garage, etc.) only upon successful verification of their assigned guest key.

In one embodiment, one or more of the access devices 21 and 22 can include a wireless access code system such as a Radio frequency identification system (RFID), or non-radio frequency lock system such as utilizing Bluetooth or Wi-Fi, for example. To this end, the system can comprise a physical lock or deadbolt that is retracted upon receipt of the wireless signal. Alternatively, a lockbox housing a physical key can be provided whereby the lockbox is opened by the wireless code sent from the guest interface device. Several commercially available products for use herein include the DKS Door king systems, Delphian Systems, Lockitron® Bolt which has Wi/FI and Bluetooth® connectivity, and/or the Sentriguard lockbox by SentriLock®, for example. In such an embodiment, the guest key can include a wireless code that can be generated by the platform provider 140 and delivered to the guest interface device 101 for storage on the device. A copy of the code can be sent to the on-site server 25 for comparison each time a guest attempts to unlock one of the access devices 21 or 22 during their stay.

In one embodiment, one or more of the access devices 21 and 22 can include a biometric lock system utilizing a camera for facial recognition, a fingerprint scanner and/or voice match capability. Several commercially available products for use herein include the August Smart Lock®, HID®, Brivo API, Nuki, August® smart Lock Pro 3rd Generation, Kwikset® Kevo, Kwikset Kevo Convert, Kwikset Premis, Lockitron® Bolt, LockState® RemoteLock, Schlage Connect, Schlage© Sense, Sesame Smart Lock, Ultraloq® UL3 BT and Yale® Assure Lock. Amazon@ Lock API and Kisi platform. Apple® HomeKit with Schlage Sense, August Smart Lock Pro, Amazon Alexa® with Kwikset Kevo, August Smart Lock Pro, Samsung® SmartThings Budget: Kwickset 910, Schlage Connect, iTunes with August Smart lock sets, DKS Doorking systems and Google® Play Kwikset Kevo, among others, for example.

In such an embodiment, the guest key can include a stored image of the guest’s face, a scanned image of the guests fingerprints and/or voice samples of the guest captured by the guest interface device during the initial identity verification and/or registration process. This information can be stored by the system database and sent to the on-site server for comparison each time a guest attempts to engage one of the access devices 21 or 22 during their stay using only their biometrics.

Although described above as including new platform specific community access devices 22, other embodiments are contemplated wherein the on-site server 25 can communicate with one or more different types of existing “native” community access components. Such a feature beneficially allows the system 100 to be used with existing systems and not requiring the community associations to expend capital in upgrading or replacing existing systems.

For example, if a community has an existing computer controller or connected smart lock system for providing residents with access to community locations such as the main doors of a building, access to building elevators, access to the pool or parking garages, for example, the server 25 of the platform 20 can be programmed to communicate with that existing system to selectively provide access to guests using their guest interface device 101.

To this end, an embodiment of the system is designed to work with lock systems having integrated wireless access code systems, camera locks and software currently known in the market and has the capability to add new lock systems and software as new products are introduced to the market.

In either instance, platform 20 allows a guest renting a specific unit having a specific access device 21 to access that unit using the guest key provided in the Guest Portal on their interface device 101 throughout the rental period. If the rental agreement includes access to community amenities such as a gym, parking garage or pool, for example, the guest will be able to unlock the specific access devices 22a-22z assigned to those areas during their stay.

In either instance, each time a guest unlocks or attempts to unlock an access device, the local server 25 will note the activity and will report the same to the platform provider 140. In this regard, property owners will be able to see the activities of only the guests which have rented their units, but the community association will be able to see activities from all guests. Such information allows the community association to maintain a record of every guest at the community over a period of time, along with a listing of the property owners who rented the units.

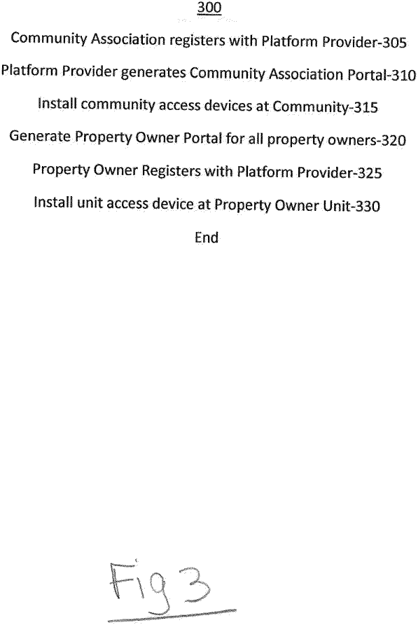

Method 300 for implementing a rental guest verification system will now be described with respect to FIG. 3. Although described below with respect to particular steps, this is for illustrative purposes only, as the methodology described herein can be performed in a different order than shown and/or can include any number of other steps.

As shown at FIG. 3, the method can begin at step 305 wherein the community Association can register with the Platform Provider. As described herein, the registration process can include any number of different seps such as providing information about the community including information about each dwelling/unit within the community, and community amenities such as parking, pool, fitness center, beach access, etc. Financial obligations such as subscription fees for using the system (if any) can be accounted for during this step.

Next, the method can proceed to step 310 wherein the platform provider can generate a community association portal for access by the community management interface device. As described herein, the community portal can include any number of different interface pages for allowing the community association to utilize the system functionality. For example, the community portal can allow the community interface device to communicate with Property Owner interface devices, guest interface devices and the access platform server to send and receive information pertaining to guest rentals, guest identities, and guest access to the community areas.

Next, the method can proceed to step 315 wherein the community access platform can be installed at the community property. To this end, server 25 can be installed at a central location and connected to platform provider 140 over the network. Also, a plurality of community access devices 22 can be installed at specific locations throughout the community property such as the building doors, elevators, pool gate, parking garage, etc. Once installed, each of the devices can be connected to server 25.

Next, the method can proceed to step 320 wherein the community interface device can instruct the platform provider 140 to generate a Property Owner portal for each dwelling/unit at the community. Once created, individual property owners can access their portal using their personal computer (e.g., property owner interface device 110).

Next, the method can proceed to step 325 wherein a property owner wishing to rent their unit using the system can undergo a registration process with the platform provider. As described herein, the registration process can include any number of different seps such as providing information about their unit within the community, attending to any payment obligations, and linking accounts to any third-party listing sites such as VRBO®, for example, on which the unit may be offered as a short-term rental.

Upon conclusion of the registration process, the method can proceed to step 330 wherein an access device 21 can be installed at the registered unit of the Property Owner. Once installed, the device can be connected to the on-site server 25 and linked to the Property Owner portal.

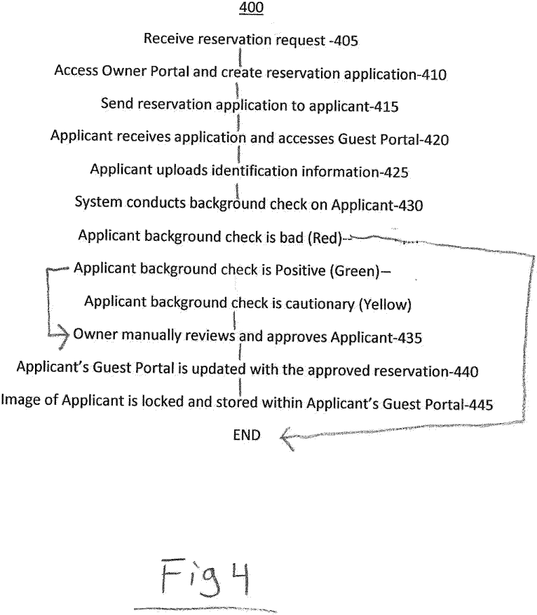

A method 400 of using the rental guest verification system to reserve and conduct a background check on an Applicant will now be described with respect to FIG. 4. The method can begin at step 405 where the Property Owner receives a reservation request from a listing site or other location indicating that a potential customer wants to book their property.

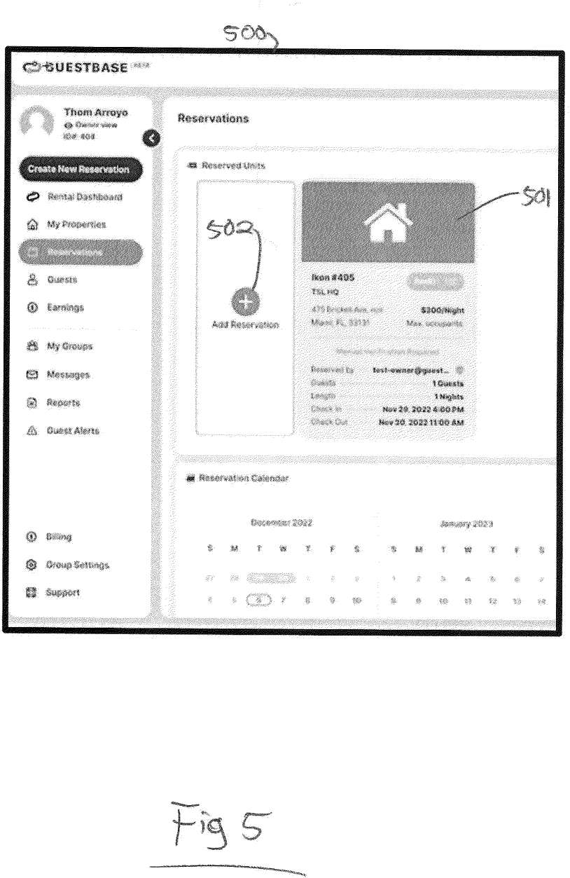

Upon receiving the request, the method can proceed to step 410 where the Property Owner can access their Owner portal to send a reservation application to the applicant. One embodiment of the Owners Portal can include the presentation screen 500 provided in FIG. 5. As shown, the Owners Portal can provide a property owner with information about all their units which correspond to the community or communities participating with the Provider Platform. In the present example, the Property Owner can see their existing reservations 501, and can Create a New Reservation by selecting tab 502.

When selected, a pop-up screen will appear where the Property Owner can enter the contact information (e.g., name, telephone number, email, etc.) of the applicant seeking to rent their unit, which was received by the listing site. Upon providing the contact information the method will proceed to step 415 where the system can send a text or email reservation link to the applicant.

At step 420, the applicant can receive the reservation link and access a Guest Portal that is generated by the system for them. The applicant can access their Guest Portal through a web browser, or by downloading the Rental Guest Verification App.

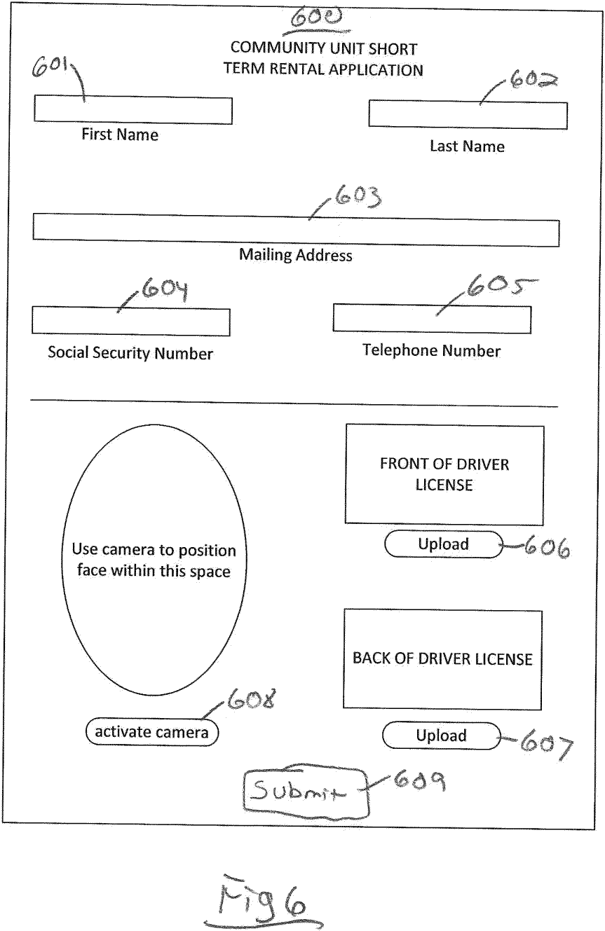

Upon accessing the Guest Portal, the method can proceed to step 425 where the applicant can undergo a background check and identity verification. This step can require the applicant to provide information about themselves and to upload various identity documents. One exemplary embodiment of the Guest Portal Application screen 600 which can be generated by the Platform Provider is shown at FIG. 6. As shown, the exemplary screen 600 can request information such as the applicants’ First Name 601, Last Name 602, current Mailing Address 603, Social Security Number 604 and/or Telephone number 605. Additionally, the screen can include functionality for the applicant to upload the Front 606 and Back 607 sides of their Driver’s License, and to utilize the onboard camera of their smartphone/interface device 101 on which screen 600 is displayed to take a candid picture 608 of their face. Of course, this is an exemplary listing of information that may be required.

Upon uploading the documents and clicking submit 609, the method can proceed to step 430 where an identity confirmation and background check can be conducted on the Applicant. In one embodiment, the information submitted by the applicant can be sent directly to a third-party company offering identity verification services and criminal background checks. Such a feature advantageously ensures that the Property Owner does not see certain critical information (such as the applicants’ social security number, for example), which could expose the applicant to potential identity theft.

In either instance, upon completion of the identity verification and background check, the system can assign the applicant a green flag, a yellow flag, or a red flag. In one embodiment, a green flag can indicate that the applicant’s identity was successfully verified, and that either no criminal record wase detected, or that any detected criminal records were below the threshold established in the contract between the Community Association and the background searching company. For example, some communities may allow applicants to rent units within their communities who have misdemeanor convictions, or other minor offenses. As such, if the Applicant’s background check results in a green flag, the system can notify the Property Owner and the method can automatically proceed to step 440.

A red flag can indicate that a criminal record was detected, and that such criminal instance was above the established threshold for the Community Association and/or can indicate the applicant was using a false identity. If the Applicant’s background check results in a red flag, the system can notify the Property Owner that the applicant has been denied, and the method can end.

A yellow flag can indicate an inconclusive result of the background check that necessitates further attention before allowing the applicant to rent the unit. In such a situation, the method can proceed to step 435 where the system can send a notification to the Property Owner to contact the Applicant for additional information and/or to manually approve or deny the application.

In either instance, upon approval of the rental application, the method will proceed to step 440 where the Applicant will be notified that their application has been accepted, and the reservation details will be updated in the applicant’s Guest Portal. Finally, at step 445 images of the applicant used during the identity verification and background check can be stored in the database and linked to the applicant’s Guest Portal for later comparison.

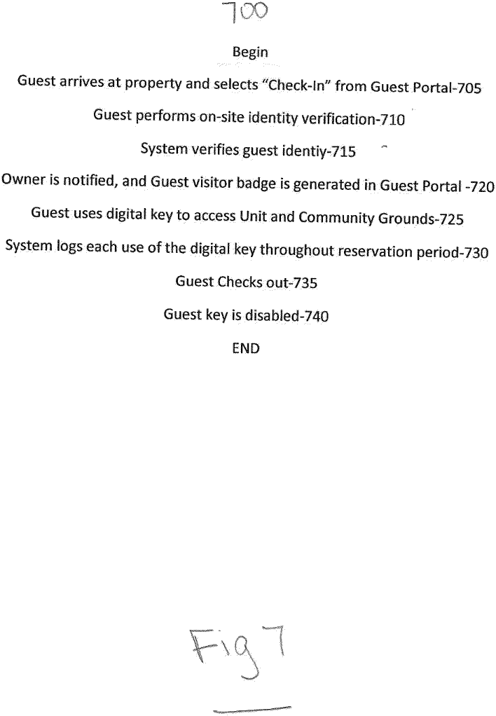

A method 700 of using the Rental Guest Verification System to access a rental unit and community grounds will now be described with respect to FIG. 7. To this end, the method can begin at step 705 where the guest can access their Guest Portal upon arriving at the community.

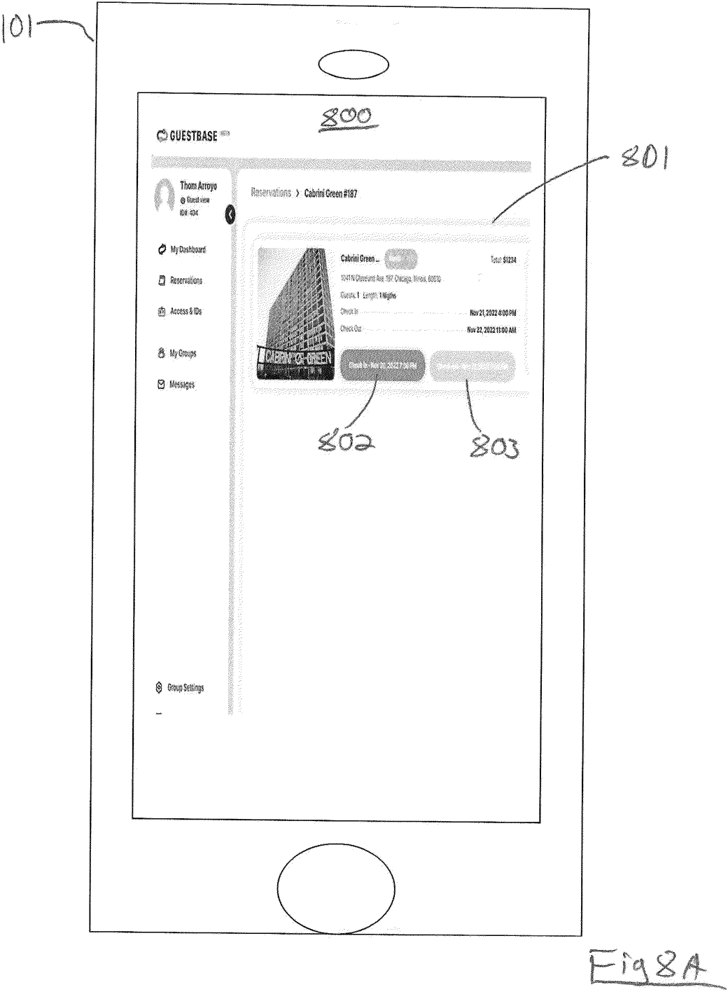

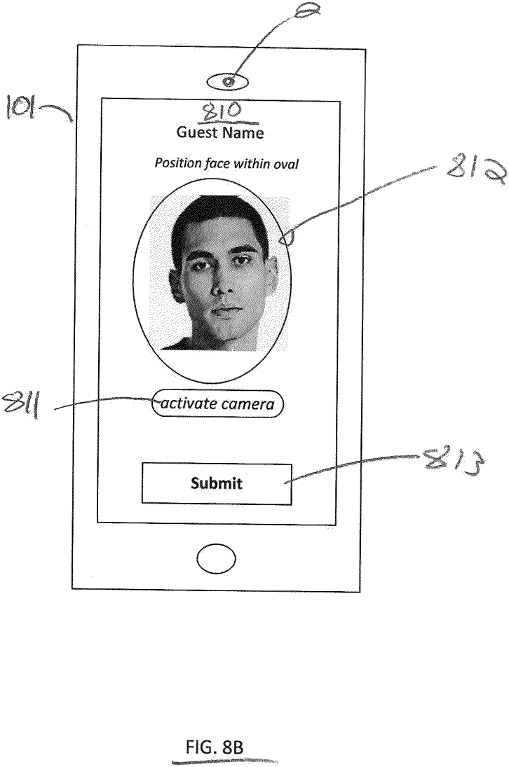

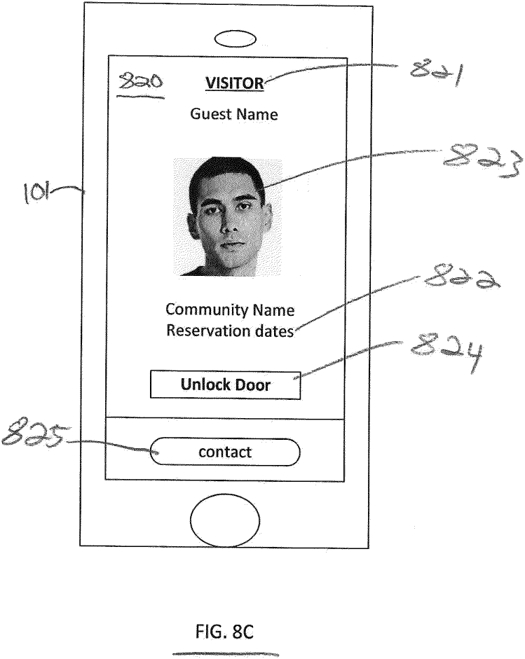

One embodiment of the Guest Portal can include the reservation presentation screen 800 provided at FIG. 8A. As shown, the Guest Portal can show the property and reservation details at tab 801 and can provide the guest with a check-in tab 802 and check-out tab 803. Upon selecting the check-in tab 802, the method can proceed to step 710 where the guest can perform an on-site identity verification.

FIG. 8B illustrates one exemplary Guest Portal identity verification screen 810 that can be generated by the system in response to the guest selecting Check-in tab 802. As shown, the Guest Portal can access 811 the camera 2 of the smartphone/interface device 101 on which the Guest Portal screen is displayed, and the user can position their face within the indicated boundary 812. When so positioned, the guest can select Submit 813.

Next, the method can proceed to step 715 where the system can verify that the person attempting to check-in at the property is the same guest that was previously verified in step 430. To this end, the image captured by the camera 811 at step 710 can be compared with the images stored as a part of the background check at step 445. Additionally, the system can utilize the location tracking feature of the smartphone 101 on which the Guest Portal is displayed to ensure the guest is at the physical location of the Unit when they performed the on-site identity verification step of 710.

Upon successful on-site identity verification, the method can proceed to step 720 where the Owner is notified via the Owners Portal that the guest has checked in, and the system can generate a digital guest Visitor Badge having a digital key for use by the guest during their reservation period.

FIG. 8C illustrates one exemplary Guest Visitor Badge screen 820 that can be generated by the system upon successful on-site identity verification described at step 715. As shown, the screen can include a designation 821 that the named individual is an approved visitor of the community during the listed reservation period 822. A photograph 823 of the guest can be provided, and an Unlock Door tab 824 can be displayed. A contact tab 825 can also be provided in order to allow the guest to communicate with the Property Owner during their stay. Such communications may comprise text, voice or video chat which may be conducted between the interface devices 101 and 110 via the system 100, or via any other known communication means.

At step 725 the guest can use their guest key to unlock the unit access device 21 for their rental unit, and any of the community access devices 22 associated with their reservation (e.g., Gym, pool, etc.) for the duration of their stay. As noted above, the guest key can include a unique code, character, or other signal that is linked to the Guest Portal.

In the present example, the guest key is activated by positioning the interface device 101 adjacent to an access device 21 or 22 and depressing the Unlock Door tab 824 in the Guest Portal. Upon depressing the tab, the guest portal will instruct the device 101 to transmit the stored wireless signal using the phones integrated wireless device (e.g., Wi-Fi, Bluetooth, NFC, etc.) which will unlock the device.

Throughout the guest’s stay at the property, they can utilize the Unlock Door feature on their Guest Badge screen to unlock doors as needed. Moreover, the visual information on the badge (e.g., picture, name and dates of stay) can be used, if necessary, by the guest in the event they are questioned by on-site security, or other such individuals.

Throughout their stay, each time the guest uses their guest key, the system can log the attempt at step 730. Logs for all guests can be available to the Community Association and logs for guests of Property Owners will be available to the individual Property Owners.

Finally, at the conclusion of their stay, the guest can use their Guest Portal to Check out at step 735, at which time a notification will be sent to the Property Owner, and the guest key and Guest Badge will be deactivated at step 740.

Accordingly, the above-described system and method provides a secure mechanism for allowing Property Owners and Community Associations to verify that guests who complete rental applications are the same guests who are at the property. The system also provides a secure mechanism for controlling access to community grounds and provides an auditable log for Community Associations outlining who and when guests are on property.

As to a further description of the manner and use of the present invention, the same should be apparent from the above description. Accordingly, no further discussion relating to the manner of usage and operation will be provided.

As described herein, one or more elements of the device 100 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A rental guest verification system, comprising:
a community access platform having a unit access device that is configured to selectively allow access to a rental unit within a community;
a platform provider system that is in communication with the unit access device;
a property owner portal that is operable by a property owner using a property owner interface device; and
a guest portal that is operable on a guest interface device,
wherein the property owner portal includes functionality for receiving a reservation request and for submitting a rental application to the guest portal,
wherein the platform provider includes functionality for performing an identification verification check on a user of the guest portal, and
wherein the guest portal includes functionality for unlocking the unit access device using a digital key upon successful identification verification.

2. The system of claim 1, wherein the unit access device comprises:
a physical lock that is secured onto a door of a rental unit of the property owner.

3. The system of claim 2, wherein the physical lock includes a wireless transceiver that is configured to communicate wirelessly with an external device.

4. The system of claim 3, wherein the digital key is transmitted from the guest interface device to the wireless transceiver to unlock the unit access device.

5. The system of claim 1, wherein the unit access device comprises:
a physical lock box that is secured onto a door of a rental unit of the property owner.

6. The system of claim 5, wherein the physical lock box includes a wireless transceiver that is configured to communicate wirelessly with an external device.

7. The system of claim 6, wherein the digital key is transmitted from the guest interface device to the wireless transceiver to unlock the lock box.

8. The system of claim 1, further comprising:
at least one community access device that is positioned within a community at which the rental unit is located.

9. The system of claim 8, wherein the at least one community access device comprises:
a physical lock that is secured onto a door of a building at which a rental unit of the property owner is located.

10. The system of claim 9, wherein the physical lock includes a wireless transceiver that is configured to communicate wirelessly with an external device.

11. The system of claim 10, wherein the digital key is transmitted from the guest interface device to the wireless transceiver to unlock the community access device.

12. The system of claim 1, wherein the guest portal includes functionality for uploading a photo identification of the user undergoing the identity verification.

13. The system of claim 12, wherein the guest portal includes functionality for capturing an image of the guest undergoing identity verification.

14. The system of claim 13 wherein the captured image is stored by the platform provider and linked to the guest portal.

15. The system of claim 1, wherein the platform provider includes functionality for automatically generating the guest key and linking the guest key to the guest portal upon the successful identification verification.

16. The system of claim 1, wherein the platform provider includes functionality for automatically denying the reservation request upon an unsuccessful identification verification.

17. The system of claim 1, wherein the property owner portal includes functionality for allowing the property owner to manually approve or deny the reservation request upon an inconclusive identification verification.
